(19) United States
(12) Patent Application Publication
(10) Pub. No.: US 2023/0298142 A1
(43) Pub. Date: Sep. 21, 2023

(54) IMAGE DEBLURRING VIA SELF-SUPERVISED MACHINE LEARNING

(71) Applicant: QUALCOMM Incorporated, San Diego, CA (US)

(72) Inventors: Jamie Menjay LIN, San Diego, CA (US); Diaa H J BADAWI, Chicago, IL (US); Hong CAI, San Diego, CA (US); Fatih Murat PORIKLI, San Diego, CA (US)

(21) Appl. No.: 17/655,427

(22) Filed: Mar. 18, 2022

(51) Int. Cl. G06T 5/00; G06T 7/194; G06T 5/50

(52) U.S. Cl. CPC G06T 5/003; G06T 5/002; G06T 7/194; G06T 5/005; G06T 5/50; G06T 2207/20081; G06T 2207/20084

(57) ABSTRACT

Certain aspects of the present disclosure provide techniques for machine learning-based deblurring. An input image is received, and a deblurred image is generated based on the input image using a neural network, comprising: generating a feature tensor by processing the input image using a first portion of the neural network, generating a motion mask by processing the feature tensor using a motion portion of the neural network, and generating the deblurred image by processing the feature tensor and the motion mask using a deblur portion of the neural network.

### INTRODUCTION

Aspects of the present disclosure relate to image deblurring using machine learning.

Motion-induced blurring is a common issue in a wide variety of image capture and image analysis systems. Often, the blurring can significantly degrade the captured images (whether captured as individual images, or as frames of a video) of moving objects (e.g., vehicles, people, and the like). Further, motion-induced blurring can occur due to ego motions (e.g., motion of the image capture device itself). In many conventional systems, blurred images (even if only slightly blurry) are either completely useless (e.g., as they cannot be analyzed, evaluated, or decoded) or are unreliable (e.g., because the analysis may be inaccurate).

Some conventional methods have been introduced to provide image deblurring. Typically, these conventional systems involve dense regression for image deblurring, generally resulting in suboptimal results (e.g., with residual blurs). Further, these conventional techniques incur significant computational expense.

Additionally, some conventional systems require more than one image to derive optical flow estimates between the images, in order to compensate object and/or global motions for deblurring. The requirement of multiple images results not only in higher computational cost and memory requirements, but also in increased processing latency (e.g., as the deblurring requires at least a time period spanning two image frames).

Moreover, conventional systems generally require supervised learning in order to guide a deblur network through training. This not only requires costly data annotation, but also makes the network subject to the limited availability of dataset samples. This results in limited accuracy in real deployments.

Accordingly, techniques are needed for improved image deblurring via machine learning techniques.

### BRIEF SUMMARY

Certain aspects provide a method of deblurring images, comprising: receiving an input image; generating a first deblurred image based on the input image using a neural network, comprising: generating a feature tensor by processing the input image using a first portion of the neural network; generating a motion mask by processing the feature tensor using a motion portion of the neural network; and generating the first deblurred image by processing the feature tensor and the motion mask using a deblur portion of the neural network.

Certain aspects provide a method of training a neural network for image deblurring, comprising: generating a first deblurred image based on processing an input image using an image sharpening neural network comprising a first portion, a motion portion, and a deblur portion; generating a first blurred image by processing the first deblurred image using a reblur operation; and refining the image sharpening neural network based at least in part on the first blurred image.

Other aspects provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example workflow for image deblurring using machine learning.

FIG. 2 depicts an example workflow for using a segmentation model to bootstrap an image sharpening model.

FIG. 3 depicts an example workflow for self-supervised training of an image sharpening machine learning model.

FIG. 4 depicts an example workflow for blur synthesis using segmentation models.

FIG. 5 depicts an example flow diagram illustrating a method of training an image sharpening model.

FIG. 6 depicts an example flow diagram illustrating a method of using segmentation models to bootstrap training of an image sharpening model.

FIG. 7 depicts an example flow diagram illustrating a method of training an image sharpening model using self-supervision.

FIG. 8 depicts an example flow diagram illustrating a method of generating deblurred images using a trained image sharpening model.

FIG. 9 depicts an example flow diagram illustrating a method of deblurring images using a trained image sharpening model.

FIG. 10 depicts an example flow diagram illustrating a method of training an image sharpening model to deblur images.

FIG. 11 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for improved image deblurring (also referred to as image sharpening) via self-supervised machine learning. Although neural networks are used as example machine learning models in some examples described herein, aspects of the present disclosure can be implemented using a wide variety of machine learning architectures. In aspects, the image deblurring can be used to deblur not only individual images, but also video data (e.g., deblurring each frame in a sequence of one or more frames or images in the video).

In some aspects, an image sharpening network (also referred to in some aspects as an image deblurring network) is trained to derive a motion mask specifying regions of input images that have motion blur. The network can then perform image deblurring based on the input image and the derived motion mask. That is, in some aspects, the image sharpening network deblurs only the regions indicated by the motion mask (which may be referred to in some aspects as sparse deblurring). This can significantly reduce computational expense (as only a subset of the image is operated on by the deblur portion of the network) while maintaining good deblurring performance.

In some aspects, the image sharpening network can handle blurs caused by both ego motion (e.g., motion of the camera itself) as well as foreground or object motions. For example, the motion mask may indicate specific regions of motion blur, or may indicate global blur (e.g., that the whole image is blurred). Based on the estimated motion regions of the motion mask (which may indicate the entire image), the image sharpening network may perform deblurring in the indicated regions. As motion is generally relative, in some aspects, the image sharpening network may optionally use a defined or configured threshold, below which the motion is deemed not significant enough to be indicated for deblurring. For example, when the global motion is non-zero, but insignificant compared to the configured motion threshold, the image sharpening network may ignore this global (e.g., ego) motion (by not indicating it in the motion mask) and focus on regions of foreground object motions (having more blur).

In some aspects of the present disclosure, the system can iteratively perform subsequent iterations of motion mask derivation (based on the deblurred image from the prior iteration), as well as a subsequent iteration of image deblurring based on this prior deblurred image (from the previous iteration) and the newly-derived motion mask. That is, the system may apply the deblurred output image as new input image to the network, enabling iterative deblurring to be performed (e.g., removing some blur with each pass through the network). This iterative deblurring process can improve model performance and accuracy. For example, images with little blur can be processed quickly and efficiently using fewer iterations, while images having substantial blur can still result in improved and unblurred output through additional iterations. Further, regions with little blur can be effectively deblurred using a smaller number of passes, while regions of the same image having more blur can continue deblurring through additional passes.

In some aspects, the motion mask derivation and image deblurring described herein requires only a single input image. That is, contrary to conventional systems, aspects of the present disclosure do not need two or more input images to produce optical flow estimates in order to indicate regions of motion. This further reduces computational complexity and latency of the system (e.g., because the system need not receive, process, or store multiple images, need not have space in memory for two or more images, need not wait for the second image to be captured or provided, and the like).

Additionally, in some aspects, the image sharpening network (including motion mask derivation and image deblurring) can be performed using a self-supervised approach, in which a module is used to synthesize a blurry image by reblurring an output (deblurred) image into a blurry one based on the generated motion mask.

In some aspects, in addition to (or instead of) self-supervised training, the system can use a segmentation model to generate its own blurred input in order to train the image sharpening network. For example, the system may use a segmentation model to extract a set of foreground pixels (e.g., pixels that include, or may include, blurry objects) and background pixels. The foreground pixels may be artificially blurred and recombined with the background pixels to yield synthesized blurred input. In at least one aspect, the background pixels are processed using an inpainting network to fill in the (removed) foreground pixels, as discussed in more detail below. In an aspect, inpainting may correspond to filling in specified pixels or regions in an input image based on the surrounding pixels, as discussed in more detail below.

In at least one aspect, this segmentation approach is used to bootstrap the network. For example, to perform a cold start (e.g., starting the training cycle from scratch without labeled exemplars), or when the training pipeline has not been operating stably, the system may use this segmentation approach to bootstrap the training process using (synthesized) blurry images with corresponding sharp images. In one aspect, once the training framework operates stably, the segmentation components can be discarded in favor of self-supervised training, discussed in more detail below.

Aspects of the present disclosure provide a variety of improvements over conventional approaches. In deployments using the derived motion masks to provide explicit localization of image regions having motion, sparse deblurring can be used to enable significant reduction in the image area that undergoes deblurring. This is particularly useful when the motion in an image is sparse. For example, when the image is of a stationary scene with moving bicycles, only the localized regions corresponding to the bicycles needs to be deblurred. Thus, this approach can enable significant reduction in deblurring computational complexity, which in turn reduces processing cycles, power usage, and latency.

Additionally, aspects that use iterative deblurring by taking the deblurred output image as the input to the image sharpening network enable more stages of the deblurring process, which allows the system to address residual blurs (e.g., blur left in an image after one or more deblurring operations). This enables more refinement, particularly in images of fast-moving objects that have more pixels affected by motions, than can be suitably handled in conventional single-iteration approaches.

Moreover, the self-supervised learning techniques described herein enable significantly improved learning for motion mask derivation and image deblurring from an arbitrarily large number of data samples, without the need for extensive (and largely manual) annotations and labeled training data.

### Example Workflow for Image Deblurring using Machine Learning

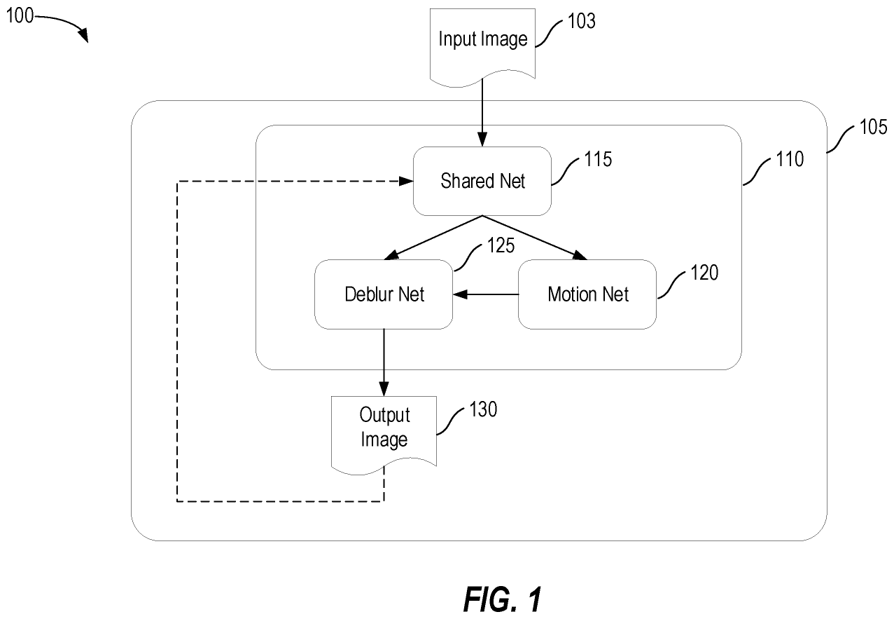

FIG. 1 depicts an example workflow 100 for image deblurring using machine learning.

In the illustrated example, an input image 103 is received by a deblurring system 105. In various aspects, the deblurring system 105 may be implemented using one or more software components, one or more hardware components, or a combination of hardware and software components. Additionally, though depicted as a single discrete system for conceptual clarity, in aspects, the various operations and components of the deblurring system 105 may be combined or distributed across any number of components, systems, and devices.

In an aspect, the input image 103 may include some amount of blur. For example, motion blur may be present due to motion of object(s) in the input image 103, due to movement of the imaging sensor that captured the input image 103, and the like. In some aspects, the input image 103 is provided to the deblurring system 105 in response to determining that the image includes blur. That is, the image may be evaluated using one or more techniques to determine its quality and whether it includes blur. In one such aspect, images are selectively processed by the deblurring system 105 only if blur (or some threshold level of blur) is detected. In other aspects, images may be provided to the deblurring system 105 without such analysis. For example, all images captured using a given camera or in a given location (e.g., a warehouse) may be processed using the deblurring system 105.

As illustrated, the input image 103 is provided to an image sharpening network 110. In the illustrated example, the image sharpening network 110 is a neural network that has been trained to deblur input images. In various aspects, other machine learning model architectures can be used. In the depicted example, the image sharpening network 110 is composed of a number of components including a shared net 115, a motion net 120, and a deblur net 125. Though depicted as discrete components for conceptual clarity, in some aspects, the operations of each component may be combined or distributed across any number of components.

Generally, the shared net 115, motion net 120, and deblur net 125 each correspond to a respective subnet (e.g., a set of one or more layers of a neural network) of the image sharpening network 110.

In the illustrated example, the shared net 115 is generally trained to generate feature tensors based on input images. In an aspect, the shared net 115 is shared between the motion net 120 and deblur net 125 to account for the various insights, learned during training, that are common to both. That is, the task of the motion net 120 and deblur net 125 may both depend at least in part on the same underlying insights and features. That is, aspects of the image that are learned to be relevant to one task (e.g., deriving the motion mask) may also be relevant in performing the other (e.g., to deblur the image). As such, in the illustrated example, a shared net 115 is used to provide the initial feature extraction for each subsequent subnet. In some aspects, the shared net 115 may be referred to as a backbone net or a feature extraction net. During training, the shared net 115 can be refined (e.g., using backpropagation) via both downstream subnets (e.g., the deblur net 125 and the motion net 120), allowing it to glean insights gathered by both downstream subnets.

Generally, the motion net 120 is trained to generate motion masks based on input images (e.g., based on the feature tensor generated by the shared net 115 using an input image 103). In an aspect, the motion mask indicates region(s) of the input image 103 that have blur (e.g., motion blur). That is, the motion mask may indicate regions or pixels that are blurred due to motion, as opposed to other optical blur (e.g., due to an out-of-focus lens or incorrect depth of field). For example, in at least one aspect, the generated motion mask indicates, for each pixel in the input image 103, whether the pixel includes, depicts, or has blur.

In the illustrated example, the deblur net 125 receives the feature tensor (generated by the shared net 115) as well as the motion mask (generated by the motion net 120). Generally, the deblur net 125 is trained to deblur one or more region(s) in the input image 103. In some aspects, this deblurring is performed based in part on the motion mask. For example, the deblur net 125 may operate only on the pixel(s) indicated, by the motion mask as containing blur and refrain from processing pixels not indicated by the motion mask (or pixels indicated as not blurry). In this way, the deblurring system 105 can effectively bypass deblur processing on the region(s) that are not blurry. This targeted and localized deblurring (also referred to as sparse deblurring) can significantly reduce the computational expense of using the image sharpening network 110 because pixels representing portions of the image with no blurring need not be processed.

As illustrated, the deblur net 125 outputs an output image 130. Generally, the output image 130 includes less blur than the input image 103. That is, although the output image 130 is generally sharper than the input image 103, some blur may remain. For example, if the input image 103 was only slightly blurred, the output image 130 may be sharp. However, if the input image 103 was significantly blurred, the output image 130 may be sharper, but still containing some residual blur. In the illustrated example, the deblurring system 105 can therefore optionally provide the output image 130 as new input to the image sharpening network 110 (e.g., as input to the shared net 115).

Generally, the resulting output (generated by processing the output image 130 a second time) will again be sharper than the original output. In this way, the deblurring system 105 (e.g., an analysis component of the deblurring system 105) can iteratively deblur the original input image 103 until a satisfactorily sharp image is generated. In various aspects, the deblurring system 105 may use a variety of termination criteria to determine how many iterations to perform. For example, in one aspect, the deblurring system 105 uses a defined number of iterations (e.g., five). In some aspects, the deblurring system 105 applies one or more objective quality evaluation techniques to determine the level of blur remaining in the output image 130, and determines whether to apply another iteration based on whether this score meets defined criteria.

In another aspect, the deblurring system 105 can compare the newly-generated output image 130 with the previous output image (generated during the immediately-prior iteration). If the difference exceeds some threshold, the deblurring system 105 may determine that the image is still improving, and therefore perform another iteration. If the difference does not exceed the threshold, the deblurring system 105 can infer that the image is as sharp as it can be.

Generally, by using the trained image sharpening network 110, the deblurring system 105 is able to generate deblurred images based on input images having any amount of blur. These deblurred images can then be used for a variety of tasks, including being returned as final output (e.g., to a user, for whatever use they may desire), as input to one or more downstream processing modules (e.g., where the deblurring system 105 acts as a pre-processing step), and the like.

### Example Workflow for Training an Image Sharpening Model using a Segmentation Model

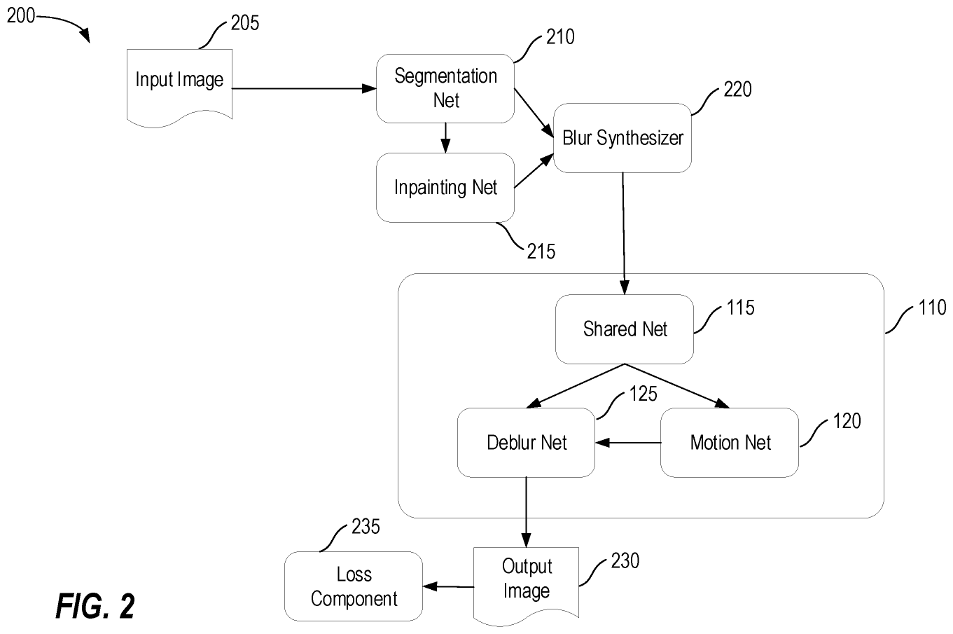

FIG. 2 depicts an example workflow 200 for using a segmentation model to bootstrap an image sharpening model. In some aspects, the workflow 200 is performed by a deblurring system (e.g., deblurring system 105 of FIG. 1).

In some aspects, the illustrated workflow 200 is used to bootstrap or initialize training of the image sharpening network 110. In at least one aspect, the workflow 200 is used when there is no labeled training data (or a small amount of training data) available. That is, in some aspects, if there is labeled training data available (e.g., a set of blurry images, each associated with a corresponding ground-truth image that is sharp or otherwise less blurry), the training can be initiated with these labeled images. If no such exemplars exist, however, the workflow 200 can be used to bootstrap the training using auxiliary data comprising only sharp images.

In the illustrated workflow 200, an input image 205 (e.g., a sharp image that has little or no motion blur) is provided to a segmentation net 210 and an inpainting net 215. In some aspects, the segmentation net 210 and inpainting net 215 (as well as the blur synthesizer 220) are included as components of the deblurring system. In other aspects, these components operate separately from the deblurring system. For example, in one aspect, a separate system may use the segmentation net 210, inpainting net 215, and blur synthesizer to generate synthesized input that the deblurring system uses to train the image sharpening network 110. In another aspect, the deblurring system may itself implement these components to generate the synthetic training input.

In the illustrated aspect, the segmentation net 210 is a trained machine learning model (e.g., neural network) configured to segment input images 205 based on the semantic meaning of the depicted objects. That is, the segmentation net 210 may be pre-trained to identify and label regions (e.g., pixels) in the input image based on a defined set of classes. For example, the segmentation net 210 may identify vehicles, bicyclists, pedestrians, signs, trees, walls, road surfaces, grass surfaces, buildings, and the like. In some aspects, the deblurring system uses a pre-trained segmentation net 210.

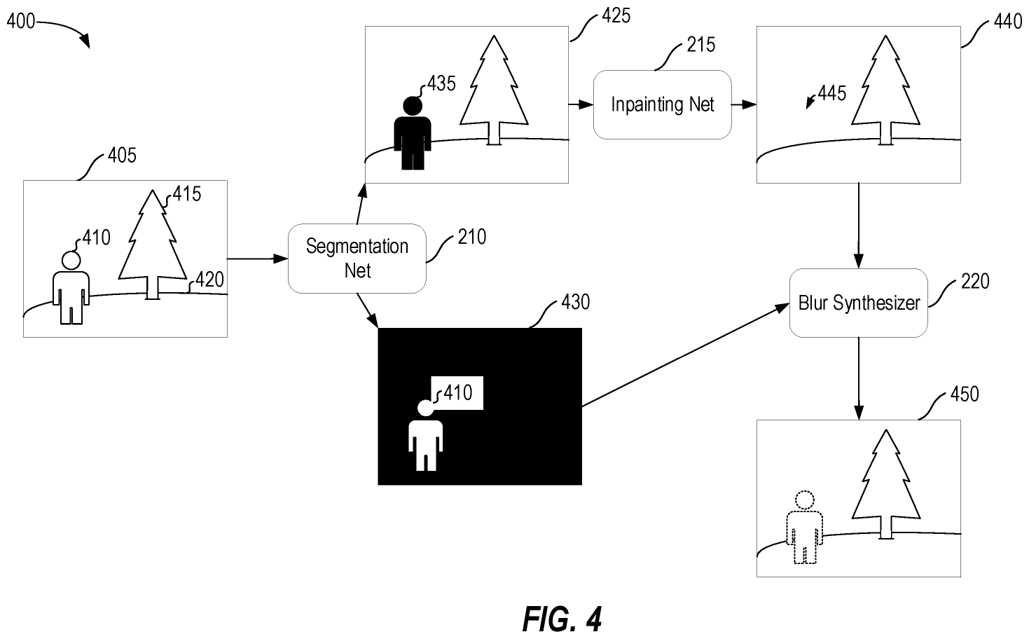

In an aspect, the deblurring system can use the output of the segmentation net 210 to delineate the input image 205 into a set of foreground elements and a set of background elements, as discussed in more detail below with reference to FIG. 4. In at least one aspect, one or more of the foreground elements are defined (e.g., by an administrator) as including mobile objects (e.g., objects that are moving or may move, such as vehicles, pedestrians, and the like) while the background elements are defined as those which do not move (e.g., signs, ground surfaces, buildings, and the like). For example, in one such aspect, a user may specify which semantic classes, output by the segmentation net 210, should be assigned to the foreground set, and which should be assigned to the background set.

In the illustrated aspect, the set of background elements are provided to an inpainting net 215. In an aspect, the inpainting net 215 is a trained machine learning model configured to fill in specified regions in an input image based on the surrounding pixels, as discussed in more detail below with reference to FIG. 4. In at least one aspect, the deblurring system uses a pre-trained inpainting net 215. In an aspect, the inpainting net 215 processes the set of background elements (from the segmentation net 210) to fill in the region(s) corresponding to the foreground elements. That is, the inpainting net 215 may receive the set of pixels corresponding to background elements, where this set of pixels includes one or more gaps or blank spaces corresponding to regions of the foreground elements. In an aspect, the deblurring system can fill in these blank regions based on the surrounding background pixels.

In the depicted workflow 200, the inpainted background elements (output by the inpainting net 215) are provided to a blur synthesizer 220, along with the set of foreground elements from the input image 205. In an aspect, the blur synthesizer 220 can generally blur the set of foreground elements using one or more blurring techniques, and aggregate the blurred foreground elements with the inpainted background elements (e.g., by superimposing the blurred foreground elements over the corresponding regions of the inpainted background elements), as discussed below in more detail with reference to FIG. 4.

In some aspects, the blur synthesizer 220 blurs the foreground elements using fixed processes (such as applying Gaussian blur using a randomized distribution). In other aspects, the blur synthesizer 220 is a trained component (e.g., a neural network) that blurs the foreground elements based on its prior training. For example, in one aspect, the blur is applied by the generator of a generative-adversarial network (GAN). In such an aspect, during training, the generator of the GAN is trained to generate blurred output based on input, and the discriminator of the GAN is trained to classify input as either true or real blurred input, or synthetic input (output by the generator). This can allow the generator to learn to generate realistic blur.

In some aspects, the blur synthesizer 220 can generate multiple blurred output images based on a single input image 205. For example, the blur synthesizer 220 may generate multiple sets of blurred foreground elements, each using different blur parameters (e.g., differing amounts of blur), thereby resulting in a set of blurry images with different amounts of blur.

Generally, the blur synthesizer 220 outputs one or more blurred images corresponding to the input image 205. In this way, the deblurring system can generate a set of synthetic blurry images based on a set of sharp or non-blurry input images 205. As illustrated, the output of the blur synthesizer 220 is provided as input to the image sharpening network 110 during training.

As discussed above, in some aspects, the segmentation net 210, inpainting net 215, and blur synthesizer 220 are used as part of a bootstrapping operation to initiate the training of the image sharpening network 110. In one such aspect, the deblurring system can determine how long to use the blur synthesizer 220 based on a variety of criteria. For example, the deblurring system may use it to generate a fixed number of blurred images, or may use the blur synthesizer 220 until other criteria (such as training stability) are met.

In some aspects, the training stability is defined based at least in part on the rate at which the model weights are changing (e.g., the magnitude of the gradients). For example, when the weights are changed, on average, by an amount less than some threshold (or the gradients are, on average, below some threshold) in a given training iteration, the system may determine that training stability has been reached. Therefore, the system may decide that the segmentation net 210, inpainting net 215, and blur synthesizer are 220 no longer needed, and begin using the self-supervised training discussed below in more detail. As other examples of handling or determining training stability, the deblurring system may control the learning rate and/or the regularization (such as L2 or weight decay) as part of the training framework. For example, the deblurring system may specify the learning rate decay with an annealing schedule, and/or specify the regularization to restrict the pace or scope of weight updates during back propagation. This can help decide when training stability is reached (e.g., when the learning rate has decayed below some threshold value, and/or the regularization has reached a defined level).

Generally, as discussed above, the shared net 115 processes the input (blurry) image to generate one or more feature tensors, which is then processed by the motion net 120 to generate a motion mask. The deblur net 125 then uses the feature tensors and motion mask to generate a deblurred output image 230, as discussed above. In the illustrated workflow 200, during training, the output image 230 is used by a loss component 235 (which may be a component of the deblurring system, or may be a separate component) to refine the model(s).

In aspects, the loss component 235 can generally compute a training loss, and use this loss to refine the image sharpening network 110 (including the deblur net 125, motion net 120, and/or shared net 115). In some aspects, one or more prior models may also be refined, such as the blur synthesizer 220, the inpainting net 215, and the segmentation net 210. In other aspects, these upstream modules are pre-trained and fixed during training of the image sharpening network 110.

Generally, the particular loss computed by the loss component 235 may vary depending on the particular implementation and stage of deployment. In one aspect, the loss component 235 can determine the loss based on differences between the output image 230 and the original (sharp) input image 205. If true labeled exemplars are used (rather than the bootstrapping segmentation net 210 and blur synthesizer 220), the loss component 235 can similarly compute the loss based on the output image 230 and the original ground-truth sharp image.

For example, the loss component 235 may directly compute the sum of the pixel-wise differences between the deblurred output image 230 and the original sharp input image 205 (e.g., using cross-entropy loss). In at least one aspect, the loss component 235 computes the loss only with respect to the region(s) indicated in the motion mask. That is, the loss component 235 may only evaluate pixel-wise differences for pixels within the identified regions that have blurred or moving objects, bypassing pixel(s) not specified by the motion mask. In other aspects, the loss component 235 computes the loss over the entire image.

In at least one aspect, the loss component 235 may additionally or alternatively compute the loss using one or more image quality metrics, such as a structural similarity index (SSIM) or peak signal-to-noise ratio (PSNR) of the deblurred output image 230. For example, using techniques such as SSIM or PSNR, the loss component 235 may generate a score indicating the quality of the deblurred output image 230. This metric or score (or the negated metric or score) can then be used as the loss that is minimized through the training process.

Further, in at least one aspect, the loss component 235 can determine the amount of blur applied by the blur synthesizer 220, and use this as the ground-truth in computing the loss. For example, if a random value (e.g., sampled from a distribution) is used to produce the blur, the loss component 235 can use this known (randomly-sampled) value to compute the loss. That is, the generated random value (e.g., used by the blur synthesizer 220 to generate the synthetic blur) in a given iteration, which indicates the severity of the blurring, can be used as the ground truth for the training. This ground truth can be compared against an estimated severity of blurring (e.g., determined and output by the deblur net 125). In this way, in some aspects, the loss component 235 can compute the difference between an estimated severity of blurring of the input (generated by the deblur net 125) and the known (ground truth) severity of blurring (indicated by the randomly-generated value) as the loss for minimization through training.

In some aspects, the loss is used to refine the image sharpening network 110 using backpropagation. For example, the loss may be used to generate a set of gradients for the deblur net 125 (indicating the direction and magnitude of change needed for each parameter of the deblur net 125), and these gradients can be backpropagated through the deblur net 125 to compute gradients for the motion net 120. The gradients from the motion net 120 can then be used (alongside the gradients from the deblur net 125) to find gradients used to refine the shared net 115.

In aspects, the deblurring system may compute a separate loss and refine the model separately for each input image 205 or for each blurred input (e.g., using stochastic gradient descent). In other aspects, the deblurring system may process a batch of images and refine the image sharpening network 110 for each batch (e.g., using batch gradient descent).

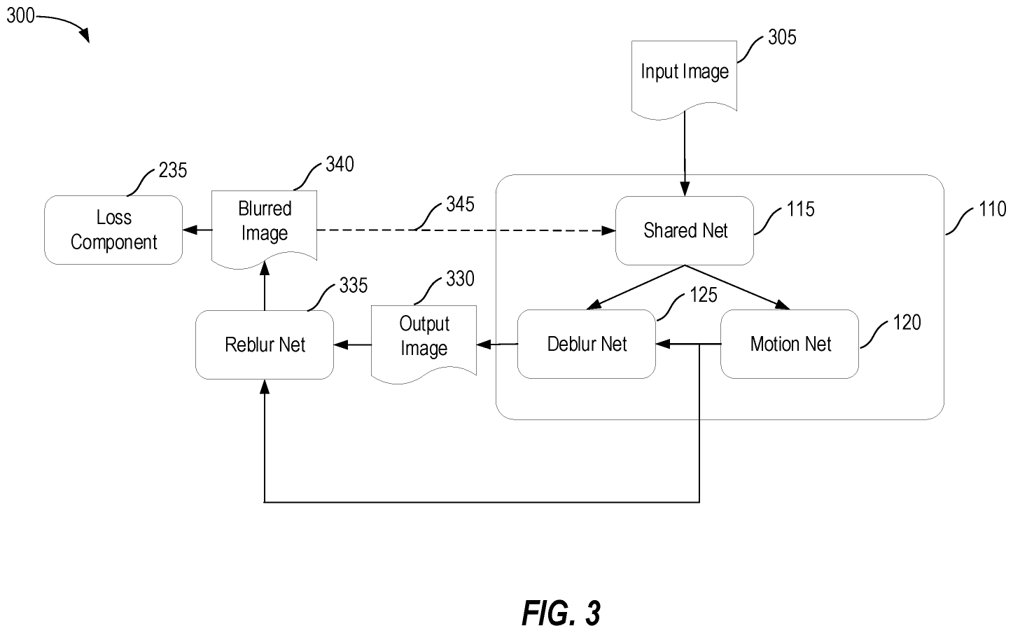

In some aspects, as discussed above, once the training process is underway (e.g., the image sharpening network 110 has begun to produce more reasonable output that is not entirely random), the deblurring system may cease use of the segmentation net 210, inpainting net 215, and blur synthesizer 220, opting instead to use a self-supervised approach discussed in more detail below with reference to FIG. 3.

### Example Workflow for Self-Supervised Training of an Image Sharpening Model

FIG. 3 depicts an example workflow 300 for self-supervised training of an image sharpening machine learning model. In some aspects, the workflow 300 is performed by a deblurring system (e.g., deblurring system 105 of FIG. 1).

In some aspects, the illustrated workflow 300 is used to train or refine the image sharpening network 110. For example, the workflow 300 may be applied after the network is bootstrapped using the segmentation network discussed above with reference to FIG. 2. That is, once the network no longer produces random results (as a result of the randomly-initiated parameters), the model may begin using self-supervision rather than supervised learning via the segmentation network. Similarly, the workflow 300 may be used to refine or optimize the image sharpening network 110 periodically (after it has been fully trained).

In the illustrated workflow 300, an input image 305 is processed using the image sharpening network 110. In some aspects, as discussed above, the input image 305 is a synthesized blurry image (e.g., generated by the blur synthesizer of FIG. 2). In other aspects, the input image 305 may be a true or real blurry image. Generally, as discussed above, the shared net 115 processes the input image 305 to generate one or more feature tensors, which is then processed by the motion net 120 to generate a motion mask. The deblur net 125 then uses the feature tensors and motion mask to generate a deblurred output image 330, as discussed above.

In the illustrated workflow 300, during training, the output image 330 is then processed by a reblur net 335 (which may be a component of the deblurring system, or may be a separate component). The reblur net 335 is generally used to generate a blurry image 340 based on the output image 330. In some aspects, the reblur net 335 corresponds to (or uses the same architecture as) the blur synthesizer 220 discussed above with reference to FIG. 2. For example, in various aspects, the reblur net 335 may use defined and fixed processes (such as applying Gaussian blur using a randomized distribution), or may be a trained component (e.g., a neural network) that blurs the foreground elements based on its prior training (e.g., as part of a GAN).

In some aspects, the reblur net 335 can generate multiple blurred images 340 based on a single output image 330. For example, the reblur net 335 may generate multiple blurred images 340, each using different blur parameters (e.g., differing amounts of blur).

In the illustrated example, the reblur net 335 also uses the motion mask (generated by the motion net 120) to generate the blurred image 340. In at least one aspect, the reblur net 335 only blurs regions (e.g., pixels) indicated in the motion mask, and bypasses processing (e.g., does not blur) regions or pixels that are not specified in the motion mask.

As illustrated, the blurred image 340 can be provided to a loss component 235 to compute a loss used to refine the image sharpening network 110. Generally, as discussed above, the particular loss computed by the loss component 235 may vary depending on the particular implementation and stage of deployment. In one aspect, the loss component 235 can determine the loss based on differences between the blurred image 340 and the original (blurry) input image 305.

For example, the loss component 235 may directly compute the sum of the pixel-wise differences between the blurred image 340 and the original input image 305 (e.g., using cross-entropy loss). In at least one aspect, the loss component 235 computes the loss only with respect to the region(s) indicated in the motion mask, as discussed above. In at least one aspect, the loss component 235 may additionally or alternatively compute the loss using one or more image quality metrics, such as SSIM or PSNR of the blurred image 340 (or the deblurred output image 330), as discussed above.

In some aspects, in addition to or instead of using the blurred image 340 to compute the loss, the deblurring system may compute the loss based on the output image 330 in a similar manner. In some aspects, the loss is used to refine the image sharpening network 110 using backpropagation (e.g., using stochastic gradient descent or batch gradient descent), as discussed above.

In the illustrated self-supervised learning workflow 300, the deblurring system creates a flow cycle of blurry and unblurred images (e.g., going from a blurred input image 305 to a deblurred output image 330, back to a blurred image 340, which can be processed again to generate a new output image 330, as illustrated by the dotted line 345). This cycle can be repeated any number of times for a given input image 305 in order to repeatedly and iteratively train the image sharpening network 110.

In some aspects, this iterative self-supervised training process is repeated until one or more termination criteria are satisfied. For example, the deblurring system may observe the achieved loss or error in each iteration (which is being minimized with stochastic gradient descent). In one such aspect, when the loss is small enough (e.g., below a defined threshold) such that the incremental improvement is reduced or approaches zero (e.g., indicating that the training is no longer improving the model), the deblurring system may stop training and/or determine to use a new input image 305 to start a new self-supervised cycle. In some aspects, the deblurring system may additionally or alternatively use a defined maximum number of cycles for each input image 305. For example, the deblurring system may process each input image 305 N times, where each of the N cycles includes a deblur operation (e.g., processing the input image 305 or blurred image 340 using the image sharpening network 110) and a reblur operation (e.g., processing the output image 330 using the reblur net 335).

In some aspects, for each of the iteration of this training cycle, the deblurring system randomly generates quantities for reblurring (via the reblur net 335), such that, in each iteration, the deblurring system generates different levels of blurriness in the image samples for training. This causes the image sharpening network 110 to undergo various levels and amounts of blurriness in training, thereby improving the eventual accuracy of the model.

Additionally, as discussed above, because the deblurring system can use a random generator function to produce the random blur quantity (in the reblur net 335), in some aspects, the deblurring system knows the (random) quantity used for each iteration, such that the random quantity can serve as the ground truth in the self-supervised workflow 300 to help derive the loss terms during training.

In some aspects, once the training workflow 300 has completed, the image sharpening network 110 can be deployed to deblur images in runtime. In various aspects, the termination criteria used to end training and drive deployment of the image sharpening network 110 can vary, and may include, for example, criteria such as whether a defined amount of time, number of training cycles, or amount of computing resources have been used.

In various aspects, the image sharpening network 110 may be deployed locally (e.g., on the same deblurring system that trained the image sharpening network 110) or on one or more other systems. For example, in at least one aspect, a first deblurring system may be used to train and refine the image sharpening network 110. The trained network can then be used by other devices and systems to deblur images during runtime. For example, the trained image sharpening network 110 may be deployed and used on smart devices (e.g., smartphones), security cameras, self-driving systems (e.g., in a car or truck), and the like.

### Example Workflow for Blur Synthesis using Segmentation Models

FIG. 4 depicts an example workflow 400 for blur synthesis using segmentation models. In some aspects, the workflow 400 is performed by a deblurring system (e.g., deblurring system 105 of FIG. 1). Generally, the workflow 400 provides additional detail for the operations of the segmentation net 210, inpainting net 215, and blur synthesizer 220, each discussed above with reference to FIG. 2.

As illustrated, an input image 405 is received and processed using the segmentation net 210. In the illustrated example, the image 405 depicts a person 410, a tree 415, and a ground and sky 420. As discussed above, the segmentation net 210 may correspond to a pre-trained semantic segmentation model configured to classify each pixel in the image 405 based on its semantic meaning or class.

As illustrated, the output of the segmentation net 210 is used to define a set of background elements or pixels 425, and a set of foreground elements or pixels 430.

Specifically, as illustrated, the tree 415, ground, and sky 420 have been classified as background elements 425, while the person 410 is included in the foreground elements 430. In an aspect, as discussed above, this delineation may be performed based on a defined mapping of semantic classes to background or foreground. For example, a user may specify classes belonging to the foreground based on whether they are mobile (and therefore may have motion blur in some images), while non-mobile elements are assigned to the background.

As indicated by the black region 435 in the background elements 425, the pixels corresponding to the person 410 are not included in the set of background elements 425. That is, the background elements 425 include a gap or blank region where these pixels were extracted. Similarly, as illustrated in the set of foreground elements 430, the pixels corresponding to the person 410 are included. However, as indicated by the black regions, the remaining pixels (all assigned to the set of background elements 425) are excluded.

In the illustrated workflow 400, the background elements 425 are then provided to an inpainting net 215, which generates a set of inpainted elements 440. As indicated by numeral 445, the blank region 435 has been infilled based on one or more surrounding pixels in the set of background pixels 425. That is, the inpainting net 215 attempts to fill these gaps intelligently in an effort to reflect what the region would look like if the removed foreground objects were not included in the original image. As discussed above, the inpainting net 215 may be a pre-trained model.

The set of inpainted background elements 440 are then provided, along with the set of foreground elements 430, to the blur synthesizer 220. As illustrated, the blur synthesizer 220 outputs a synthetic blurred image 450, where the foreground elements 430 are blurred (indicated using dashed lines for conceptual clarity), and are superimposed over the appropriate (inpainted) region(s) of the background elements 440. In some aspects, this superimposition can involve replacing some or all of the inpainted regions with the blurred foreground elements, combining or merging the elements, and the like.

As discussed above, the resulting blurred image 450 may be used to train an image sharpening network (e.g., image sharpening network 110 of FIG. 1). For example, the blurry image 450 may be used to bootstrap the training process by providing some initial blurred samples (with corresponding ground truth images 405, as well as, in some aspects, the ground truth blurred area of the image, indicated by the set of foreground elements 430) to begin training. In some aspects, as discussed above, the deblur system may transition to a self-supervised training flow (such as workflow 300 of FIG. 3) once the model training is underway.

### Example Method for Training an Image Sharpening Model

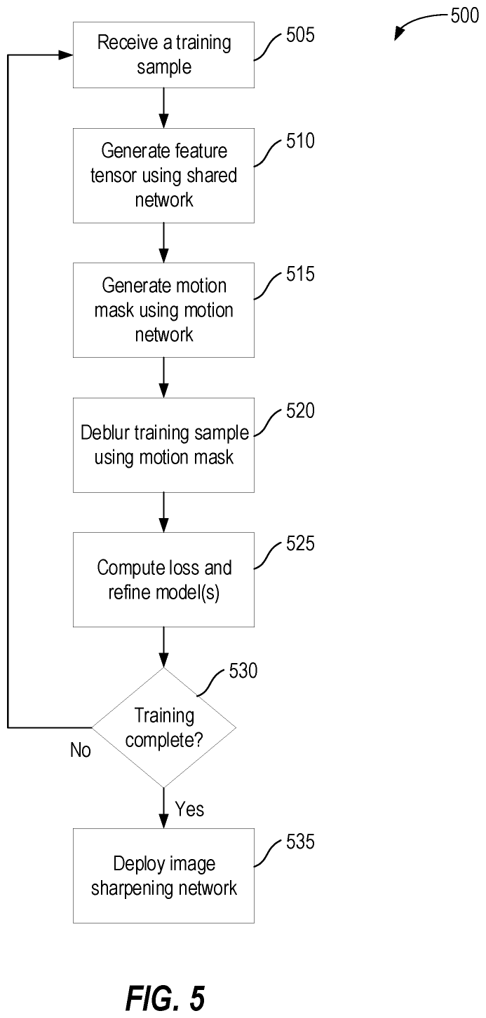

FIG. 5 depicts an example flow diagram illustrating a method 500 of training an image sharpening model. In some aspects, the method 500 is performed by a deblurring system (e.g., deblurring system 105 of FIG. 1).

At block 505, the deblurring system receives a training sample. As discussed above, in some aspects, the training sample may be a true or real sample, such as a real image with actual motion blur. In some aspects, the training sample may be a synthesized image, such as one created using the workflow 200 in FIG. 2, or the workflow 400 in FIG. 4. In at least one aspect, the training sample may be a blurred image created by reblurring an image that the deblurring system already deblurred. For example, as discussed above with reference to FIG. 3, the received sample may be used as part of a cycle of self-supervised training.

In some aspects, the nature of the training sample may vary depending on the stage or phase of the training pipeline. For example, if the deblurring system is just beginning training from scratch (e.g., where the weights and biases of the image sharpening network are initialized, such as to random values), the training sample may be a real or true blurred image (if available), or a synthesized blurred image. In some aspects, if the training pipeline is already underway (e.g., such that the image sharpening network has already been trained some, and model is beginning to produce more accurate results), the training sample may be a reblurred image used in self-supervised learning.

In some aspects, the training sample is associated with a ground-truth label or image. For example, in some aspects, the (blurred) training sample is associated with a non-blurred ground truth (e.g., a synthesized blurred image may have a corresponding original unblurred image). In some aspects, the label of the training sample corresponds to an indication of the amount of blur that was applied (e.g., one or more blur parameters applied by the blur synthesizer 220 in FIG. 2, and/or the reblur net 335 of FIG. 3).

At block 510, the deblurring system generates a feature tensor using a shared network, subnet, or model of the image sharpening model. For example, the deblurring system may process the training sample using the shared net 115 of FIGS. 1-3. As discussed above, this shared subnet or model may be shared among the multiple subsequent heads of the image sharpening network (e.g., a motion subnet and a deblur subnet) in order to allow insights gleaned by one subnet to be shared among the others. That is, learned insights useful to performing the deblurring may also be useful in feature extraction, and this improved feature extraction may also be useful in improved generation of motion masks.

At block 515, the deblurring system generates a motion mask using a motion network, subnet, or model. For example, the deblurring system may process the generated feature tensor (from block 510) using the motion net 120 of FIGS. 1-3. As discussed above, the motion mask generally indicates regions (e.g., pixels) in the input image that depict, include, or correspond to motion or blur. For example, in at least one aspect, the motion mask is a binary tensor with the same dimensionality of the input image (or the same dimensionality of the spatial dimensions of the input image, with more or fewer channels than the input image). In each element of the spatial dimensions (e.g., for each pixel in the height and width of the input image), the element may include a binary value indicating whether the pixel depicts motion blur (e.g., where a one indicates that blur is present, and a zero indicates that blur is not present). In some aspects, rather than a binary mask, the motion mask includes continuous values for each pixel. These continuous values may be compared to one or more thresholds, where values meeting the thresholds are classified as “blurred” or “blurry.”

At block 520, he deblurring system deblurs the training sample based on the generated motion mask. For example, the deblurring system may use the deblur net 125 of FIGS. 1-3. As discussed above, by using the motion mask, the deblurring system can limit processing to only those pixels or regions that have motion blur (refraining from processing regions that do not have blur), as opposed to performing deblurring on the entire image. That is, regions or pixels not specified in the motion mask may bypass the deblur processing. This can significantly reduce the computational expense of the deblur process, as well as reducing processing latency and improving deblur accuracy (e.g., because non-blurred regions are not modified). In some aspects, as discussed above, this deblurred output may be less blurry (also referred to as sharper) than the original input image, but may not be truly sharp (e.g., there may be residual blur remaining). As discussed above, in some aspects, during inferencing or runtime, the deblurring system can process this output using the image sharpening model again (e.g., beginning at block 510) to iteratively generate deblurred output.

At block 525, the deblurring system computes a loss based at least in part on the training sample, and refines the model(s) (e.g., the deblur subnet, the motion subnet, and the shared subnet of the image sharpening model). As discussed above, in some aspects, if a ground-truth (sharp) image is available for the training sample, the loss may be based on a pixel-wise difference between the sharp image and the deblurred output (either with respect to the whole image, or with respect to only those portions indicated as blurry in the motion mask). In some aspects, as discussed above, the loss may be computed based on the (known) blur parameters (which may have been randomly selected in one or more prior steps) used to create the blurry input. In some aspects, as discussed above, the loss may be computed based on processing the deblurred output using one or more objective quality measures, such as SSIM or PSNR.

Generally, refining the models includes updating or modifying one or more weights, biases, or other parameters of each portion of the image sharpening network. For example, using stochastic or batch gradient descent, the deblurring system may iteratively refine these parameters such that the deblur net generates improved deblurred images (e.g., images that are closer to the true unblurred scene), the motion net generates improved motion masks (e.g., more accurately identifying regions that need to be deblurred), and the shared feature net generates better feature tensors (e.g., tensors that are more informative or useful in performing the downstream processing). Although the depicted method 500 indicates refining the models for each individual image (e.g., using stochastic gradient descent) for conceptual clarity, in aspects, the deblurring system may instead use batch gradient descent, as discussed above.

At block 530, the deblurring system determines whether training is complete. In various aspects, this may include evaluation of a variety of termination criteria, including a maximum amount of time or computing resources spent training the models, a maximum number of training iterations, a minimum output accuracy (e.g., a minimum quality of the output images, determined using one or more objective measures such as SSIM or PSNR), and the like.

If training is not complete, the method 500 returns to block 505 to receive a subsequent training sample. In some aspects, as discussed above, this next training sample may correspond to the deblurred output (generated at block 520) after some blurring is added back in. This self-supervised cycle can enable the deblurring system to refine the model with few or no additional exemplars. For example, using relatively few annotated images (or relatively few synthesized blurred images), the deblurring system may bootstrap the model to initialize training. Subsequently, the deblurring system may use self-supervision by cycling these images repeatedly through the model, using various levels of blur, to complete the training process.

If, at block 530, the deblurring system determines that training is complete, the method 500 continues to block 535, where the image sharpening network is deployed for use in runtime. As discussed above, in some aspects, the deblurring system that trained the model also deploys it locally for use. In other aspects, the image sharpening network may be deployed and used by one or more other systems, devices, or components. For example, the deblurring system may operate in a cloud or server environment to train the image sharpening network, and the trained network may be deployed to one or more edge devices such as mobile smartphones.

Note that FIG. 5 is just one example of a method, and other methods including fewer, additional, or alternative steps are possible consistent with this disclosure.

### Example Method for Using Segmentation Models to Train Image Sharpening Models

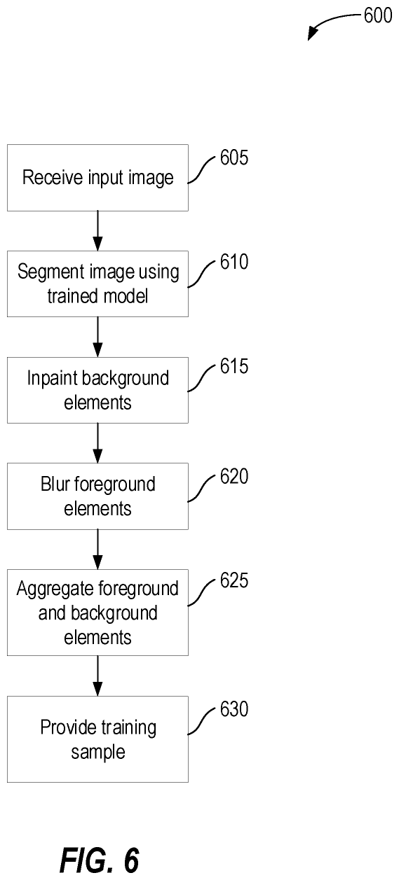

FIG. 6 depicts an example flow diagram illustrating a method 600 of using segmentation models to bootstrap training of an image sharpening model. In some aspects, the method 600 is performed by a deblurring system (e.g., deblurring system 105 of FIG. 1). In one aspect, the method 600 provides additional detail for block 505 of FIG. 5, where the deblurring system uses a segmentation model to bootstrap the training process of an image sharpening network.

At block 605, the deblurring system receives a deblurring image. In some aspects, as discussed above, this received image is a sharp or non-blurred image. Using the method 600, the deblurring system can generate a synthesized blurred image to be used as a training sample for an image sharpening network.

At block 610, the deblurring system segments the image using a trained segmentation model (such as segmentation net 210 of FIGS. 2 and 4). That is, the deblurring system processes the received (non-blurred) image using a pre-trained image segmentation model that is configured to classify each pixel or region of the image based on the semantic meaning of the depicted object(s). For example, the model may be configured to classify pixels as “pedestrian,” “sign,” “vehicle,” “ground,” “tree,” “building,” and the like.

In an aspect, the deblurring system can use these classifications or labels to segment the image into a set of foreground elements and a set of background elements. As discussed above, the foreground elements can generally correspond to objects that are inherently mobile, or otherwise may have motion blur in captured images. For example, bicycles, cars, trucks, pedestrians, and the like may all, in at least some images, be blurred due to motion of the objects. In contrast, the background elements can generally correspond to objects that are inherently stationary, or otherwise that will not generally have motion blur. For example, the road surface, buildings, trees, signposts, and the like are generally unlikely to have motion blur. In an aspect, the particular classes assigned to the foreground and background elements may vary depending on the particular segmentation model, as well as a configuration of the deblurring system (e.g., defined by a user).

At block 615, the deblurring system inpaints the set of background elements using a trained inpainting model (such as inpainting net 215 of FIGS. 2 and 4). For example, as discussed above with reference to FIG. 4, the deblurring system may use a pre-trained inpainting network to fill in the gaps or blanks left in the set of background elements (after pixels corresponding to the foreground elements are extracted). In an aspect, this context-aware inpainting generally involves selecting value(s) for each pixel in the blank region(s) based at least in part on the value(s) of one or more surrounding pixels. This can allow the inpainting network to simulate the input image as if the foreground object was not present.

At block 620, the deblurring system can blur the foreground elements using a blur model (such as blur synthesizer 220 of FIGS. 2 and 4). As discussed above, this may include using a Gaussian or other random process to generate blur, using a model (e.g., a neural network) trained to blur the elements, and the like. In some aspects, this blur is generally added to simulate motion blur of the foreground elements, enabling synthesis of an image where the foreground objects are in motion. In some aspects, the deblurring system applies the same level of blur to all foreground objects. In other aspects, the deblurring system may apply a different (random) amount of blur to each object of the foreground elements (e.g., to each disjoint region).

At block 625, the deblurring system can then aggregate the (blurred) foreground elements and the (inpainted) background elements to yield a synthesized training sample. For example, as discussed above, the deblurring system may superimpose the set of foreground elements over the set of background elements, causing each inpainted region of the background to be entirely or partially covered by a corresponding blurred foreground element. This synthesized blurred image can thereby approximate how the original input image would look if the foreground object(s) were in motion when the image was captured (or if the image was captured with a configuration that caused blur, such as a relatively slower shutter speed).

At block 630, the deblurring system then provides this synthesized training sample (e.g., at block 505 of FIG. 5) to train an image sharpening model. As discussed above, in some aspects, the method 600 is used to bootstrap or initialize the training of the image sharpening model. For example, beginning with random (or pseudo-random) parameters of the image sharpening model, the synthesized images may be used to provide some initial training. Once the initial training has begun, the self-supervised approach discussed above can be used to continue and complete training.

Note that FIG. 6 is just one example of a method, and other methods including fewer, additional, or alternative steps are possible consistent with this disclosure.

### Example Method for Self-Supervised Training of Image Sharpening Models

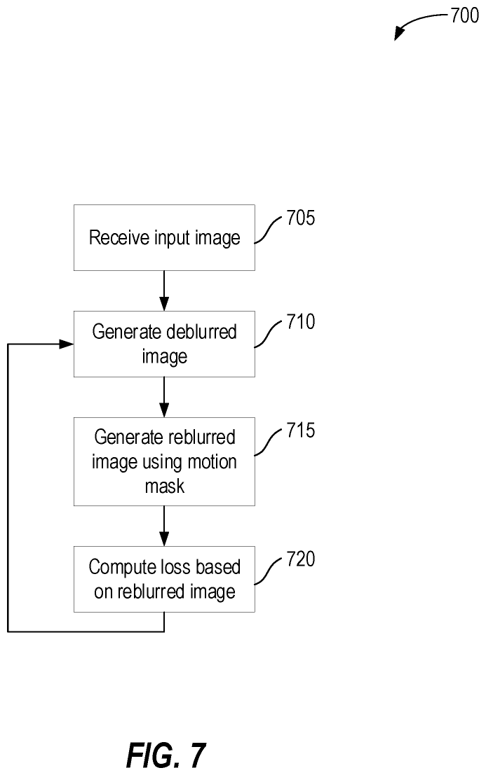

FIG. 7 depicts an example flow diagram illustrating a method 700 of training an image sharpening model using self-supervision. In some aspects, the method 700 is performed by a deblurring system (e.g., deblurring system 105 of FIG. 1). In one aspect, the method 700 provides additional detail for the self-supervised approach discussed above, allowing the deblurring system to train an image sharpening network without additional supervision.

At block 705, the deblurring system receives an input image. As discussed above, this image may correspond to a blurry ground-truth image, a synthesized blurry image, or to an image that has already been processed by the image sharpening network.

At block 710, the deblurring system generates a deblurred image for the input image based on processing the input image using an image sharpening network, as discussed above. Generally, this deblurred image contains less blur, as compared to the original input image.

At block 715, the deblurring system generates a reblurred image, based on the deblurred image, using a motion mask. For example, the deblurring system may use reblur net 335 of FIG. 3 to add blur to the deblurred image, resulting in a reblurred image with some (random) amount of blur.

At block 720, the deblurring system computes a loss for the model based on this reblurred image. For example, in some aspects, the deblurring system may compute a pixel-wise difference (for the whole image, or only for masked regions) between the reblurred image and the original blurred image. In another aspect, the deblurring system may use the blur parameters used by the reblur net to compute this loss. Additionally, as discussed above, in some aspects the deblurring system may additionally or alternatively use the deblurred image (generated at block 710) to generate a loss.

After the model has been refined based on the loss, the method 700 returns to block 710, where the deblurring system generates another deblurred image using the reblurred image as input. In this way, as discussed above, the self-supervised training pipeline can iteratively deblur and reblur an image to differing levels of blur, enabling the image sharpening model to be iteratively trained and refined without the need for additional supervision or annotated samples. In aspects, this cycle may continue until any number of termination criteria are met, such as a maximum number of cycles, a minimum accuracy of the model (e.g., determined by evaluating the deblurred image), and the like.

Note that FIG. 7 is just one example of a method, and other methods including fewer, additional, or alternative steps are possible consistent with this disclosure.

### Example Method for Generating Deblurred Images using Image Sharpening Models

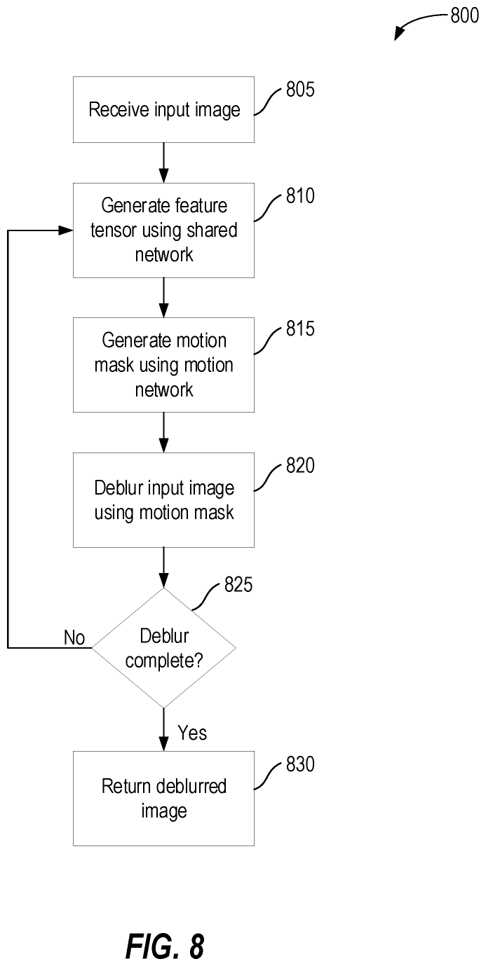

FIG. 8 depicts an example flow diagram illustrating a method 800 of generating deblurred images using an image sharpening model. In some aspects, the method 800 is performed by a deblurring system (e.g., deblurring system 105 of FIG. 1).

The method 800 begins at block 805, where the deblurring system receives an input image. In an aspect, this input image is received during runtime (e.g., after the image sharpening network has been trained). The input image may or may not depict some amount of blur. That is, in some aspects, the deblurring system processes all captured or received images using the image sharpening network. In other aspects, the deblurring system can selectively process only those captured images that are determined to include blur (e.g., based on objective quality techniques, user indication, and the like).

At block 810, the deblurring system generates a feature tensor by processing the received image using a shared portion of an image sharpening network (e.g., using the shared net 115 of FIGS. 1, 2, and 3). At block 815, the deblurring system can then generate a motion mask by processing the feature tensor using a motion portion of the image sharpening network (e.g., using the motion net 120 of FIGS. 1, 2, and 3).

Similarly, at block 820, the deblurring system deblurs the input using a deblur portion of the image sharpening network (e.g., using the deblur net 125 of FIGS. 1, 2, and 3). For example, the deblurring system can process the feature tensor, in view of the motion mask, to deblur regions indicated by the motion mask.

As discussed above, this deblurred image is generally sharper than the original input image, but may still retain some residual blur. In the illustrated example, at block 825, the deblurring system determines whether the deblurring process is complete. In various aspects, this determination may be made based on a variety of criteria. For example, the deblurring system may determine whether a predefined maximum number of deblurring cycles have been performed. In some aspects, the deblurring system determines whether the deblurred image satisfies predefined quality criteria (e.g., score thresholds for SSIM or PSNR metrics). In at least one aspect, the deblurring system compares the generated deblurred image (or the objective quality score of the current deblurred image) with the input image (or with the objective quality score of the input image), which may be a deblurred image from a prior iteration. If this difference exceeds some threshold, the deblurring system can determine that the deblur process is still improving, and therefore determine that the deblur is not complete. If the difference does not meet the criteria, the deblurring system may determine that the deblur is complete.

If the deblur is not complete, as determined at step 825, the method 800 returns to block 810, where the deblurring system processes the deblurred image (generated at block 820) anew, beginning with generating a new feature tensor based on the deblurred image. If, at block 825, the deblurring system determines that the deblur is complete, the method 800 terminates at block 830, where the deblurring system returns the deblurred image.

In various aspects, the deblurred image can then be used for a wide variety of tasks and processes, including machine learning tasks (e.g., for object recognition), for display (e.g., added to a user's gallery), and the like.

Note that FIG. 8 is just one example of a method, and other methods including fewer, additional, or alternative steps are possible consistent with this disclosure.

### Example Method for Deblurring Images using an Image Sharpening Model

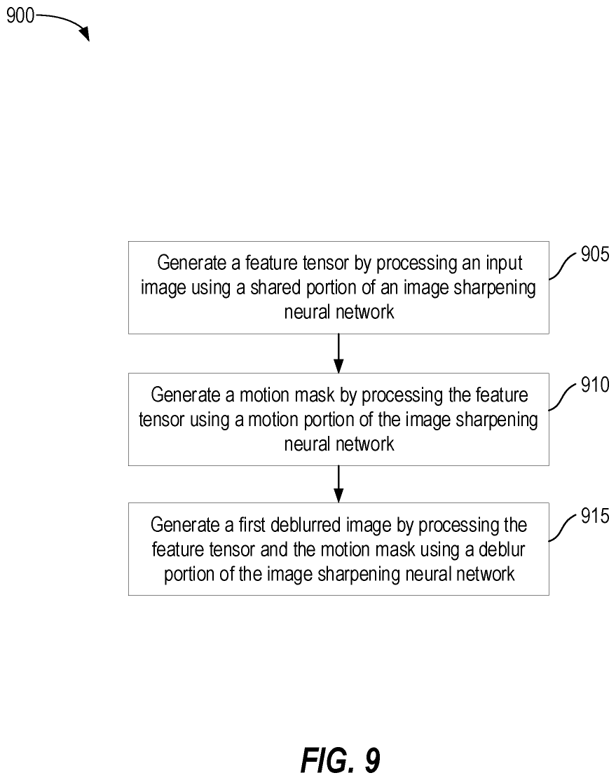

FIG. 9 depicts an example flow diagram illustrating a method of deblurring images using a trained image sharpening model. In some aspects, the method 900 is performed by a deblurring system (e.g., deblurring system 105 of FIG. 1).

At block 905, a feature tensor is generated by processing an input image using a shared portion of an image sharpening neural network.

At block 910, a motion mask is generated by processing the feature tensor using a motion portion of the image sharpening neural network.

In some aspects, the motion mask indicates regions of the input image that have motion blur.

At block 915, a first deblurred image is generated by processing the feature tensor and the motion mask using a deblur portion of the image sharpening neural network.

In some aspects, generating the first deblurred image comprises processing a subset of elements in the feature tensor, wherein the motion mask indicates that the subset of elements is blurry.

In some aspects, when generating the first deblurred image, the deblur portion of the image sharpening neural network bypasses processing elements in the feature tensor that are not indicated by the motion mask.

In some aspects, the method 900 further includes generating a second deblurred image by processing the first deblurred image using the image sharpening neural network.

In some aspects, the method 900 further includes comparing the first deblurred image and the second deblurred image, and upon determining, based on the comparison, that a difference between the first deblurred image and the second deblurred image is below a threshold, outputting the second deblurred image.

In some aspects, the method 900 further includes comparing the first deblurred image and the second deblurred image, and upon determining, based on the comparison, that a difference between the first deblurred image and the second deblurred image is greater than a threshold, generating a third deblurred image by processing the second deblurred image using the image sharpening neural network.

Note that FIG. 9 is just one example of a method, and other methods including fewer, additional, or alternative steps are possible consistent with this disclosure.

### Example Method for Training an Image Sharpening Model to Deblur Images

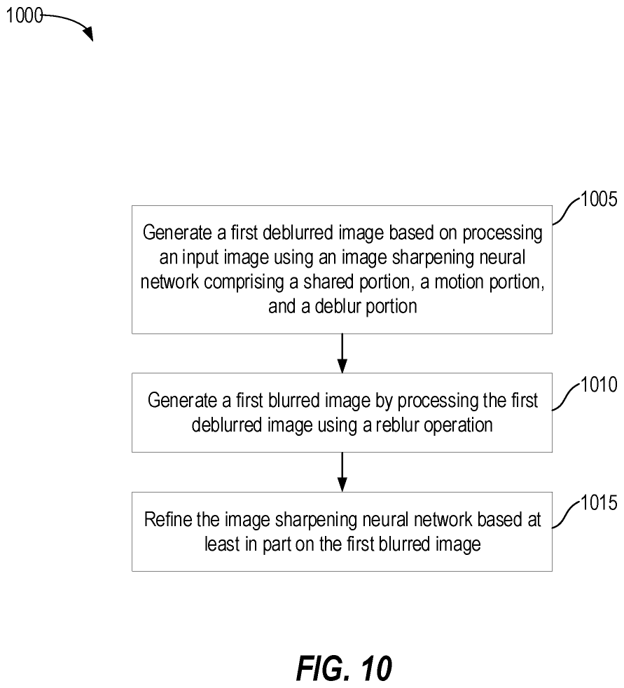

FIG. 10 depicts an example flow diagram illustrating a method of training an image sharpening model to deblur images. In some aspects, the method 1000 is performed by a deblurring system (e.g., deblurring system 105 of FIG. 1).

At block 1005, a first deblurred image is generated based on processing an input image using an image sharpening neural network comprising a shared portion, a motion portion, and a deblur portion.

In some aspects, the input image is generated by generating a set of foreground pixels and a set of background pixels by processing an original input image using a segmentation network, blurring the set of foreground pixels by applying a motion blur operation, inpainting the set of background pixels using a trained inpainting network, and aggregating the blurred set of foreground pixels and the inpainted set of background pixels.

In some aspects, segmenting the original input image comprises identifying a defined set of classes, output by the segmentation network, that correspond to moveable objects, upon determining that a first pixel in the original input image is classified to a first class of the defined set of classes, assigning the first pixel to the set of foreground pixels, and upon determining that a second pixel in the original input image is classified to a second class not included in the defined set of classes, assigning the first pixel to the set of background pixels.

In some aspects, inpainting the set of background pixels comprises, for each pixel in the set of foreground pixels, generating a new value using the inpainting network, based at least in part on the set of background pixels.

At block 1010, a first blurred image is generated by processing the first deblurred image using a reblur operation.

In some aspects, generating the first blurred image further comprises processing a motion mask, output by the motion portion of the image sharpening neural network, using the reblur operation.

In some aspects, the motion mask indicates regions of the input image that have motion blur.

In some aspects, when generating the first blurred image, the reblur operation does not operate on elements in the first deblurred image that are not indicated by the motion mask.

At block 1015, the image sharpening neural network is refined based at least in part on the first blurred image

In some aspects, refining the image sharpening neural network comprises computing a loss based on the first blurred image and the input image.

In some aspects, the method 1000 further includes generating a second deblurred image based on processing the first blurred image using the image sharpening neural network, generating a second blurred image by processing the second deblurred image using the reblur operation, and refining the image sharpening neural network based at least in part on the second blurred image.

Note that FIG. 10 is just one example of a method, and other methods including fewer, additional, or alternative steps are possible consistent with this disclosure.

### Example Processing System for Image Sharpening Models

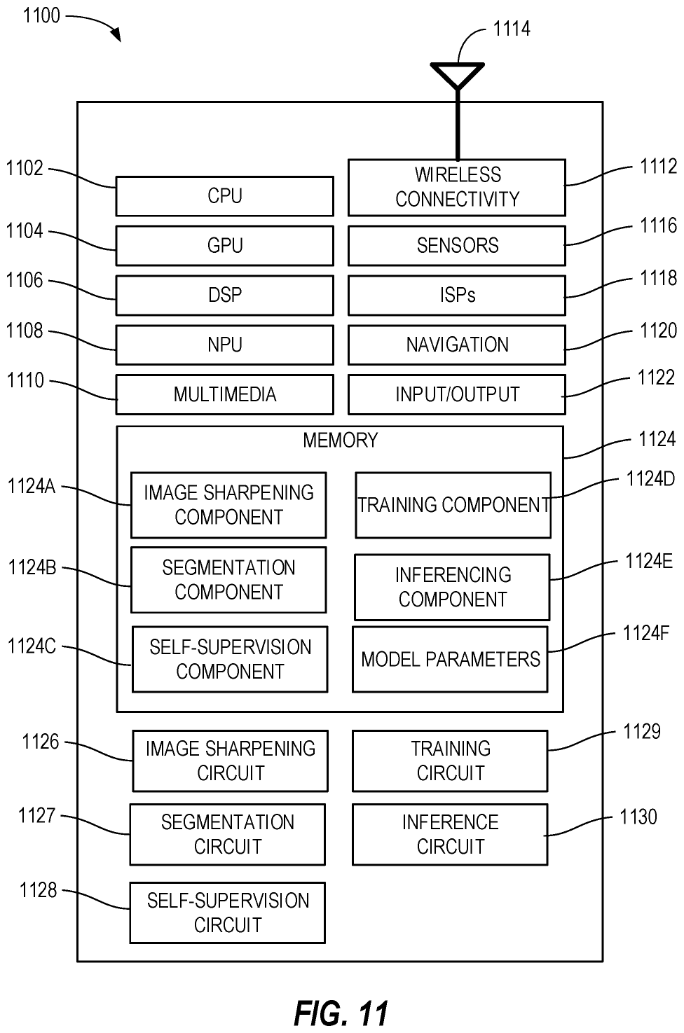

In some aspects, the workflows, techniques, and methods described with reference to FIGS. 1-10 may be implemented on one or more devices or systems. FIG. 11 depicts an example processing system 1100 configured to perform various aspects of the present disclosure, including, for example, the techniques and methods described with respect to FIGS. 1-10. In one aspect, the processing system 1100 may correspond to the deblurring system 105 of FIG. 1, as discussed above. In at least some aspects, as discussed above, the operations described below with respect to the processing system may be distributed across any number of devices. For example, one system may train the image sharpening model, while a second uses the trained model to deblur images.

Processing system 1100 includes a central processing unit (CPU) 1102, which in some examples may be a multi-core CPU. Instructions executed at the CPU 1102 may be loaded, for example, from a program memory associated with the CPU 1102 or may be loaded from a memory partition 1124.

Processing system 1100 also includes additional processing components tailored to specific functions, such as a graphics processing unit (GPU) 1104, a digital signal processor (DSP) 1106, a neural processing unit (NPU) 1108, a multimedia processing unit 1110, and a wireless connectivity component 1112.

An NPU, such as 1108, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 1108, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 1108 is a part of one or more of CPU 1102, GPU 1104, and/or DSP 1106.

In some examples, wireless connectivity component 1112 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 1112 is further connected to one or more antennas 1114.

Processing system 1100 may also include one or more sensor processing units 1116 associated with any manner of sensor, one or more image signal processors (ISPs) 1118 associated with any manner of image sensor, and/or a navigation processor 1120, which may include satellite-based positioning system components (e.g., GPS or GLONASS) as well as inertial positioning system components.

Processing system 1100 may also include one or more input and/or output devices 1122, such as screens, touch-sensitive surfaces (including touch-sensitive displays), physical buttons, speakers, microphones, and the like.

In some examples, one or more of the processors of processing system 1100 may be based on an ARM or RISC-V instruction set.

Processing system 1100 also includes memory 1124, which is representative of one or more static and/or dynamic memories, such as a dynamic random access memory, a flash-based static memory, and the like. In this example, memory 1124 includes computer-executable components, which may be executed by one or more of the aforementioned processors of processing system 1100.

In particular, in this example, memory 1124 includes an image sharpening component 1124A (which may correspond to the image sharpening network 110 in FIGS. 1-3), a segmentation component 1124B (which may correspond to the segmentation net 210, inpainting component 215, and/or blur synthesizer 220 in FIG. 2), a self-supervision component 1124C (which may correspond to the reblur net 335 of FIG. 3), a training component 1124D (which may include, for example, the loss component 235 of FIGS. 1-2), and an inference component 1124E. The memory 1124 also includes a set of model parameters 1124F (which may correspond to the parameters of the machine learning models discussed above, such as an image sharpening network including a shared subnet, a motion subnet, and a deblur subnet). The depicted components, and others not depicted, may be configured to perform various aspects of the techniques described herein. Though depicted as discrete components for conceptual clarity in FIG. 11, image sharpening component 1124A, segmentation component 1124B, self-supervision component 1124C, training component 1124D, and inference component 1124E may be collectively or individually implemented in various aspects.

Processing system 1100 further comprises image sharpening circuit 1126, segmentation circuit 1127, self-supervision circuit 1128, training circuit 1129, and inference circuit 1130. The depicted circuits, and others not depicted, may be configured to perform various aspects of the techniques described herein.

For example, image sharpening component 1124A and image sharpening circuit 1126 may be used to generate deblurred images using machine learning, as discussed above. Segmentation component 1124B and segmentation circuit 1127 may be used to segment sharp images to aid intelligent blur synthesis in order to perform initial model training, as discussed above. Self-supervision component 1124C and self-supervision circuit 1128 may be used to may be used to reblur images and enable self-supervised training cycles, as discussed above. Training component 1124D and training circuit 1129 may be used to train, refine, and/or fine-tune the models (e.g., using the workflow 200 in FIG. 2, the workflow 300 in FIG. 3, the workflow 400 in FIG. 4, the method 500 in FIG. 5, the method 600 in FIG. 6, the method 700 in FIG. 7, and/or the method 1000 in FIG. 10), as discussed above. Inference component 1124E and inference circuit 1130 may be used to generate inferences or predictions (e.g., deblurred images) using the trained image sharpening network (e.g., using the workflow 100 in FIG. 1, the method 800 in FIG. 8, and/or the method 900 in FIG. 9), as discussed above.

Though depicted as separate components and circuits for clarity in FIG. 11, image sharpening circuit 1126, segmentation circuit 1127, self-supervision circuit 1128, training circuit 1129, and inference circuit 1130 may collectively or individually be implemented in other processing devices of processing system 1100, such as within CPU 1102, GPU 1104, DSP 1106, NPU 1108, and the like.

Generally, processing system 1100 and/or components thereof may be configured to perform the methods described herein.

Notably, in other aspects, aspects of processing system 1100 may be omitted, such as where processing system 1100 is a server computer or the like. For example, multimedia component 1110, wireless connectivity 1112, sensors 1116, ISPs 1118, and/or navigation component 1120 may be omitted in other aspects. Further, aspects of processing system 1100 maybe distributed between multiple devices.

### Example Clauses

Clause 1: A method comprising: receiving an input image; generating a first deblurred image based on the input image using a neural network, comprising: generating a feature tensor by processing the input image using a first portion of the neural network; generating a motion mask by processing the feature tensor using a motion portion of the neural network; and generating the first deblurred image by processing the feature tensor and the motion mask using a deblur portion of the neural network.

Clause 2: The method according to Clause 1, wherein the motion mask indicates regions of the input image that have motion blur.

Clause 3: The method according to any one of Clauses 1-2, wherein generating the first deblurred image comprises processing a subset of elements in the feature tensor, wherein the motion mask indicates that the subset of elements contains motion blur.

Clause 4: The method according to any one of Clauses 1-3, wherein, generating the first deblurred image further comprises bypassing processing of elements in the feature tensor that are not indicated as containing motion blur by the motion mask.

Clause 5: The method according to any one of Clauses 1-4, further comprising generating a second deblurred image by processing the first deblurred image using the image sharpening neural network.

Clause 6: The method according to any one of Clauses 1-5, further comprising: comparing the first deblurred image and the second deblurred image; and upon determining, based on the comparison, that a difference between the first deblurred image and the second deblurred image is below a threshold, outputting the second deblurred image.

Clause 7: The method according to any one of Clauses 1-6, further comprising: comparing the first deblurred image and the second deblurred image; and upon determining, based on the comparison, that a difference between the first deblurred image and the second deblurred image is greater than a threshold, generating a third deblurred image by processing the second deblurred image using the image sharpening neural network.

Clause 8: A method comprising: generating a first deblurred image based on processing an input image using an image sharpening neural network comprising a first portion, a motion portion, and a deblur portion; generating a first blurred image by processing the first deblurred image using a reblur operation; and refining the image sharpening neural network based at least in part on the first blurred image.

Clause 9: The method according to Clauses 8, wherein refining the image sharpening neural network comprises computing a loss based on the first blurred image and the input image.

Clause 10: The method according to any one of Clauses 8-9, further comprising: generating a second deblurred image based on processing the first blurred image using the image sharpening neural network; generating a second blurred image by processing the second deblurred image using the reblur operation; and refining the image sharpening neural network based at least in part on the second blurred image.

Clause 11: The method according to any one of Clauses 8-10, wherein generating the first blurred image further comprises processing a motion mask, output by the motion portion of the image sharpening neural network, using the reblur operation.

Clause 12: The method according to any one of Clauses 8-11, wherein the motion mask indicates regions of the input image that have motion blur.

Clause 13: The method according to any one of Clauses 8-12, wherein, when generating the first blurred image, the reblur operation does not operate on elements in the first deblurred image that are not indicated by the motion mask.

Clause 14: The method according to any one of Clauses 8-13, wherein the input image is generated by : generating a set of foreground pixels and a set of background pixels by processing an original input image using a segmentation network; generating a blurred set of foreground pixels by blurring the set of foreground pixels using a motion blur operation; inpainting the set of background pixels using a trained inpainting network; and aggregating the blurred set of foreground pixels and the inpainted set of background pixels.

Clause 15: The method according to any one of Clauses 8-14, wherein segmenting the original input image comprises: identifying a defined set of classes, output by the segmentation network, that correspond to moveable objects; upon determining that a first pixel in the original input image is classified to a first class of the defined set of classes, assigning the first pixel to the set of foreground pixels; and upon determining that a second pixel in the original input image is classified to a second class not included in the defined set of classes, assigning the first pixel to the set of background pixels.

Clause 16: The method according to any one of Clauses 8-15, wherein inpainting the set of background pixels comprises, for each pixel in the set of foreground pixels, generating a new value using the inpainting network, based at least in part on the set of background pixels.

Clause 17: A system, comprising: a memory comprising computer-executable instructions; and one or more processors configured to execute the computer-executable instructions and cause the processing system to perform a method in accordance with any one of Clauses 1-16.

Clause 18: A system, comprising means for performing a method in accordance with any one of Clauses 1-16.

Clause 19: A non-transitory computer-readable medium comprising computer-executable instructions that, when executed by one or more processors of a processing system, cause the processing system to perform a method in accordance with any one of Clauses 1-16.

Clause 20: A computer program product embodied on a computer-readable storage medium comprising code for performing a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving an input image;
generating a first deblurred image based on the input image using a neural network, comprising:
generating a feature tensor by processing the input image using a first portion of the neural network;
generating a motion mask by processing the feature tensor using a motion portion of the neural network; and
generating the first deblurred image by processing the feature tensor and the motion mask using a deblur portion of the neural network.

2. The method of claim 1, wherein the motion mask indicates regions of the input image that have motion blur.

3. The method of claim 1, wherein generating the first deblurred image comprises processing a subset of elements in the feature tensor, wherein the motion mask indicates that the subset of elements contains motion blur.

4. The method of claim 3, wherein, generating the first deblurred image further comprises bypassing processing of elements in the feature tensor that are not indicated as containing motion blur by the motion mask.

5. The method of claim 1, further comprising generating a second deblurred image by processing the first deblurred image using the image sharpening neural network.

6. The method of claim 5, further comprising:
comparing the first deblurred image and the second deblurred image; and
upon determining, based on the comparison, that a difference between the first deblurred image and the second deblurred image is below a threshold, outputting the second deblurred image.

5. The method of claim 5, further comprising:
comparing the first deblurred image and the second deblurred image; and
upon determining, based on the comparison, that a difference between the first deblurred image and the second deblurred image is greater than a threshold, generating a third deblurred image by processing the second deblurred image using the image sharpening neural network.

8. A computer-implemented method, comprising:
generating a first deblurred image based on processing an input image using an image sharpening neural network comprising a first portion, a motion portion, and a deblur portion;
generating a first blurred image by processing the first deblurred image using a reblur operation; and
refining the image sharpening neural network based at least in part on the first blurred image.

9. The method of claim 8, wherein refining the image sharpening neural network comprises computing a loss based on the first blurred image and the input image.

10. The method of claim 8, further comprising:
generating a second deblurred image based on processing the first blurred image using the image sharpening neural network;
generating a second blurred image by processing the second deblurred image using the reblur operation; and
refining the image sharpening neural network based at least in part on the second blurred image.

11. The method of claim 8, wherein generating the first blurred image further comprises processing a motion mask, output by the motion portion of the image sharpening neural network, using the reblur operation.

12. The method of claim 11, wherein the motion mask indicates regions of the input image that have motion blur.

13. The method of claim 11, wherein, when generating the first blurred image, the reblur operation does not operate on elements in the first deblurred image that are not indicated by the motion mask.

14. The method of claim 8, wherein the input image is generated by:
generating a set of foreground pixels and a set of background pixels by processing an original input image using a segmentation network;
generating a blurred set of foreground pixels by blurring the set of foreground pixels using a motion blur operation;
inpainting the set of background pixels using a trained inpainting network; and
aggregating the blurred set of foreground pixels and the inpainted set of background pixels.

15. The method of claim 14, wherein segmenting the original input image comprises:
identifying a defined set of classes, output by the segmentation network, that correspond to moveable objects;
upon determining that a first pixel in the original input image is classified to a first class of the defined set of classes, assigning the first pixel to the set of foreground pixels; and
upon determining that a second pixel in the original input image is classified to a second class not included in the defined set of classes, assigning the first pixel to the set of background pixels.

16. The method of claim 14, wherein inpainting the set of background pixels comprises, for each pixel in the set of foreground pixels, generating a new value using the inpainting network, based at least in part on the set of background pixels.

17. A system, comprising:
a memory comprising computer-executable instructions; and
one or more processors configured to execute the computer-executable instructions and cause the system to perform an operation comprising:
receiving an input image;
generating a first deblurred image based on the input image using a neural network, comprising:
generating a feature tensor by processing the input image using a first portion of the neural network;
generating a motion mask by processing the feature tensor using a motion portion of the neural network; and
generating the first deblurred image by processing the feature tensor and the motion mask using a deblur portion of the neural network.

18. The system of claim 17, wherein the motion mask indicates regions of the input image that have motion blur.

19. The system of claim 17, wherein generating the first deblurred image comprises processing a subset of elements in the feature tensor, wherein the motion mask indicates that the subset of elements contains motion blur.

20. The system of claim 19, wherein, generating the first deblurred image further comprises bypassing processing of elements in the feature tensor that are not indicated as containing motion blur by the motion mask.

21. The system of claim 17, the operation further comprising generating a second deblurred image by processing the first deblurred image using the image sharpening neural network.

22. The system of claim 21, the operation further comprising:
comparing the first deblurred image and the second deblurred image; and
upon determining, based on the comparison, that a difference between the first deblurred image and the second deblurred image is below a threshold, outputting the second deblurred image.

23. The system of claim 21, the operation further comprising:
comparing the first deblurred image and the second deblurred image; and
upon determining, based on the comparison, that a difference between the first deblurred image and the second deblurred image is greater than a threshold, generating a third deblurred image by processing the second deblurred image using the image sharpening neural network.

24. A system, comprising:
a memory comprising computer-executable instructions; and
one or more processors configured to execute the computer-executable instructions and cause the system to perform an operation comprising:
generating a first deblurred image based on processing an input image using an image sharpening neural network comprising a first portion, a motion portion, and a deblur portion;
generating a first blurred image by processing the first deblurred image using a reblur operation; and
refining the image sharpening neural network based at least in part on the first blurred image.

25. The system of claim 24, wherein refining the image sharpening neural network comprises computing a loss based on the first blurred image and the input image.

26. The system of claim 24, the operation further comprising:
generating a second deblurred image based on processing the first blurred image using the image sharpening neural network;
generating a second blurred image by processing the second deblurred image using the reblur operation; and
refining the image sharpening neural network based at least in part on the second blurred image.

27. The system of claim 24, wherein:
generating the first blurred image further comprises processing a motion mask, output by the motion portion of the image sharpening neural network, using the reblur operation,
wherein the motion mask indicates regions of the input image that have motion blur, and
when generating the first blurred image, the reblur operation does not operate on elements in the first deblurred image that are not indicated by the motion mask.

28. The system of claim 24, wherein the input image is generated by:
generating a set of foreground pixels and a set of background pixels by processing an original input image using a segmentation network;
generating a blurred set of foreground pixels by blurring the set of foreground pixels using a motion blur operation;
inpainting the set of background pixels using a trained inpainting network; and
aggregating the blurred set of foreground pixels and the inpainted set of background pixels.

29. The system of claim 28, wherein segmenting the original input image comprises:
identifying a defined set of classes, output by the segmentation network, that correspond to moveable objects;
upon determining that a first pixel in the original input image is classified to a first class of the defined set of classes, assigning the first pixel to the set of foreground pixels; and
upon determining that a second pixel in the original input image is classified to a second class not included in the defined set of classes, assigning the first pixel to the set of background pixels.

30. The system of claim 28, wherein inpainting the set of background pixels comprises, for each pixel in the set of foreground pixels, generating a new value using the inpainting network, based at least in part on the set of background pixels.
